(19) United States
(12) Patent Application Publication
(10) Pub. No.: US 2015/0003839 A1
(43) Pub. Date: Jan. 1, 2015

(54) OPTICAL TRANSCEIVER

(71) Applicant: Yuuji Minota, Tokyo (JP)

(72) Inventor: Yuuji Minota, Tokyo (JP)

(21) Appl. No.: 14/371,659

(22) PCT Filed: Jan. 11, 2013
(86) PCT No.: PCT/JP2013/050475

§ 371 Date: Jul. 10, 2014

(30) Foreign Application Priority Data
Jan. 13, 2012 (JP) 2012-004895

(51) Int. Cl. H04B 10/43; H04B 10/25

(52) U.S. Cl. CPC H04B 10/43; H04B 10/2503
USPC 398/138

(57) ABSTRACT

An optical transceiver includes: a main board; a flexible board provided on a surface of the main board; an optical module mounted on the flexible board; and an optical fiber connected to the optical module. A position of the flexible board with respect to the main board is freely adjusted in a length direction of the optical fiber.

### TECHNICAL FIELD

The present invention relates to an optical transceiver used for optical communication.

### BACKGROUND ART

Patent Documents 1 and 2 disclose an example of an optical transceiver used for optical communication. In an optical transmission and reception device (corresponding to an optical transceiver) described in Patent Document 1, an optical transmission assembly and an optical reception assembly are arranged in tandem on a circuit board having a connection terminal for electrically connecting to an information system device. Moreover, the optical transmission assembly and an optical connector are connected by an internal transmission tape fiber, and the optical reception assembly and the optical connector are connected by an internal reception tape fiber.

In the optical transceiver described in Patent Document 2, an optical module is mounted on each surface of two flexible boards. Moreover, a first heat radiating member is arranged between the optical modules, with the flexible board sandwiched therebetween.

The optical module is a component incorporated in the optical transceiver. The optical module is configured by integrating major components required for transmission and reception of an optical signal, such as a transmission laser diode, a reception laser diode, and a wave division multiplexing filter. As in the optical transmitter and receiver described in Patent Document 1, there is an optical module in which an optical transmission assembly and an optical reception assembly being a transmission and reception system are formed as separate components.

### PRIOR ART DOCUMENTS

### Patent Documents

Patent Document 1: Japanese Unexamined Patent Application, First Publication No. 2008-090232

Patent Document 2: Japanese Unexamined Patent Application, First Publication No. 2011-233837

### SUMMARY OF THE INVENTION

### Problem to be Solved by the Invention

Recently, most devices such as a communication device have been downsized. Downsizing of the optical transceiver has naturally been required. In order to respond to this requirement, the optical transceiver needs to have a structure in which internal components such as an optical fiber, an optical connector, and a card edge board can be housed in a base (casing) efficiently. Particularly, the respective internal components need to be mounted on a main board and housed in the base, without being subjected to constraints of the internal components such as a fiber length tolerance, a position of the optical connector, and a position of the card edge board, and without applying a load such as one which would greatly bend the optical fiber.

The optical transmission and reception device described in Patent Document 1 realizes high performance, high reliability, and low production cost. In Patent Document 1, there is no description of a method of downsizing the optical transmission and reception device. The optical transceiver described in Patent Document 2 improves heat radiating performance of the optical module. Also in Patent Document 2, there is no description of a downsizing method.

The present invention takes into consideration the above situation. An exemplary object of the present invention is to provide an optical transceiver that can house internal components such as an optical fiber, an optical connector, and a card edge board in a base efficiently, thereby realizing downsizing.

### Means for Solving the Problem

An optical transceiver of the present invention includes: a main board; a flexible board provided on a surface of the main board; an optical module mounted on the flexible board; and an optical fiber connected to the optical module. A position of the flexible board with respect to the main board is freely adjusted in a length direction of the optical fiber.

### Effect of the Invention

According to an exemplary embodiment of the present invention, internal components such as an optical fiber, an optical connector, and a card edge board can be housed in a base efficiently, and downsizing of the optical transceiver can be realized.

### BRIEF DESCRIPTION OF THE DRAWINGS

FIG. 1 is a diagram showing a schematic configuration of an optical transceiver according to an exemplary embodiment of the present invention.

FIG. 2 is an exploded assembly diagram of the optical transceiver of FIG. 1.

FIG. 3 is a perspective view showing an overview of an optical transceiver body constituting the optical transceiver of FIG. 1.

FIG. 4 is an internal structure diagram of the optical transceiver of FIG. 1.

FIG. 5A is a partially enlarged view of the optical transceiver body constituting the optical transceiver of FIG. 1.

FIG. 5B is a partially enlarged view of the optical transceiver body constituting the optical transceiver of FIG. 1.

FIG. 6 is an internal structure diagram for explaining a feature of the optical transceiver of FIG. 1.

FIG. 7 is an internal structure diagram of a modification example of the optical transceiver of FIG. 1.

### EMBODIMENTS FOR CARRYING OUT THE INVENTION

Hereinafter, an exemplary embodiment for implementing the present invention will be described in detail with reference to the drawings.

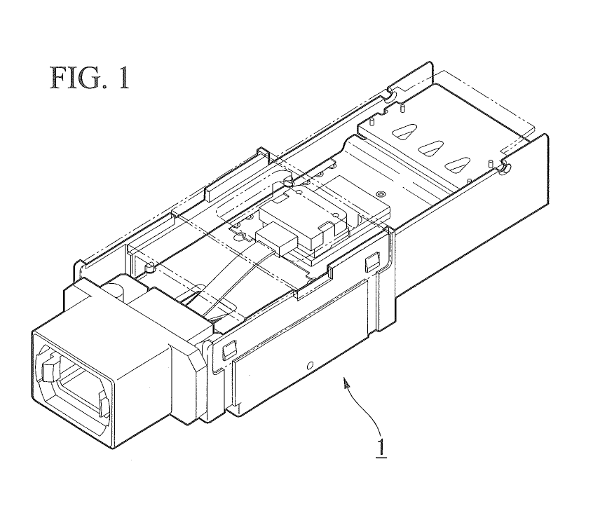

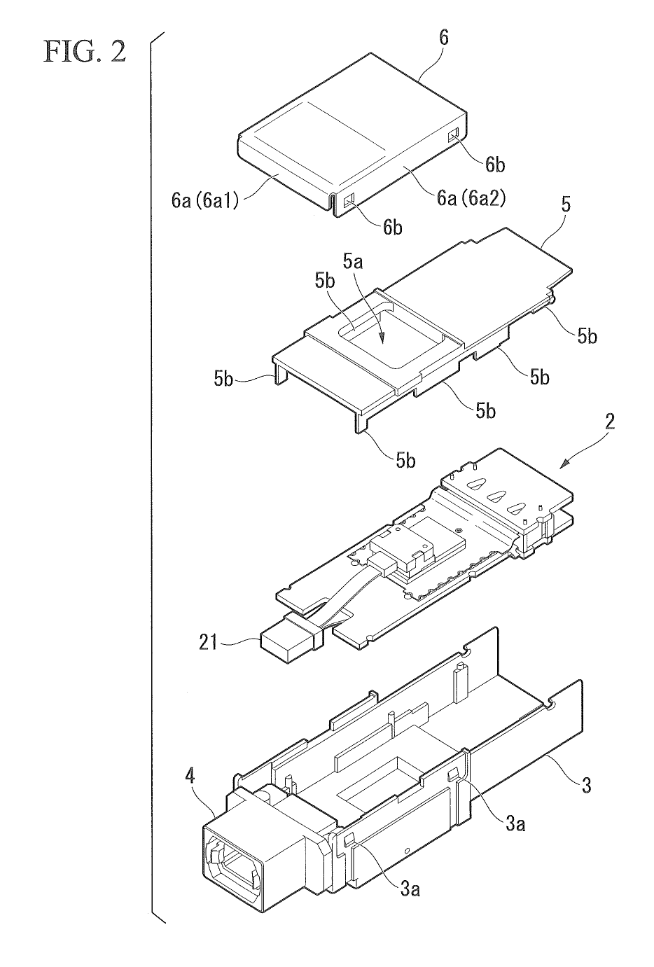

FIG. 1 is a perspective view showing an overview of an optical transceiver according to an exemplary embodiment of the present invention. FIG. 2 is an exploded assembly diagram of the optical transceiver of FIG. 1. As shown in FIG. 1 and FIG. 2, an optical transceiver 1 according to the present exemplary embodiment includes an optical transceiver body 2, a base (casing) 3, an optical adaptor 4, an inner cover 5, and an outer cover 6. The base 3 houses the optical transceiver body 2. The optical adaptor 4 is attached to a tip section of the base 3. The inner cover 5 covers a part of the base 3. The outer cover 6 covers a window part 5a formed in the inner cover 5.

The base 3 is formed in a rectangular shape with a cross-section formed substantially in a U shape. The above-mentioned optical adaptor 4 is attached to the tip section of the base 3 (the left side on the sheet in FIG. 2 is designated as the tip section). Two protrusions 3a are formed at respective upper edge portions on the opposite side surfaces of the base 3. The protrusions 3a are used for fitting the outer cover 6 to the base 3. The optical transceiver body 2 is housed in the base 3. Details of the optical transceiver body 2 will be described later. The inner cover 5 has locking parts 5b which are formed substantially in a plate-like shape. The locking parts 5b are used for positioning at the time of fitting the inner cover 5 to the base 3. The inner cover 5 includes the square window part 5a provided from a central part of the inner cover 5 toward a tip section (the left side on the sheet in FIG. 2 is designated as the tip section). The outer cover 6 is formed in a rectangular shape. Respective four sides of the outer cover 6 are bent at right angles. Portions of the outer cover 6 bent at right angles are referred to as “extending parts 6a (6a1 and 6a2). The four extending parts 6a of the outer cover 6 are formed by two short extending parts 6a1 and two long extending parts 6a2 longer than the short extending parts 6a1. Fitting holes 6b are formed in both sides of the long extending parts 6a2. The fitting holes 6b are formed respectively at a position fitted to the protrusion 3a formed on the side surface of the base 3, at the time of fitting the outer cover 6 to the base 3.

After the optical transceiver body 2 is housed in the base 3, the inner cover 5 and the outer cover 6 are fitted to the base 3 in the order of inner cover 5 and outer cover 6. The optical transceiver body 2 is housed in the base 3 so that an optical connector 21 of the optical transceiver body 2 is incorporated in the optical adaptor 4. The internal size and shape of the optical adaptor 4 are formed so that the optical connector 21 is fitted therein. Consequently, the optical connector 21 is fitted to the optical adaptor 4 appropriately and reliably.

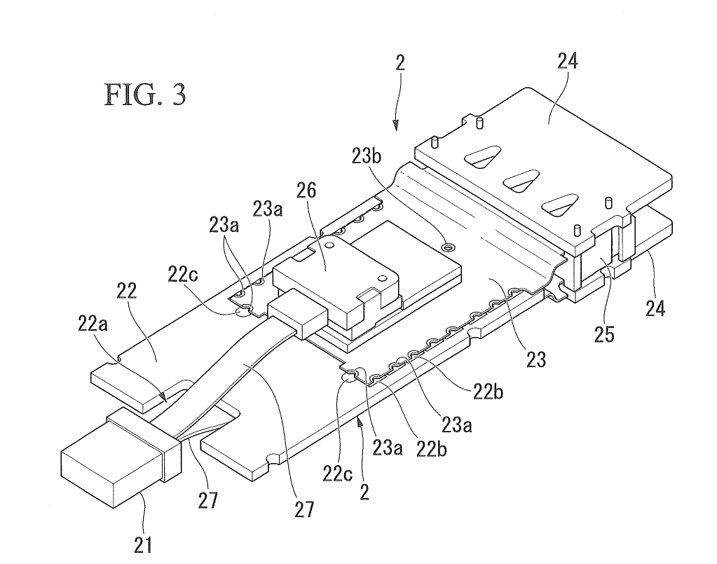

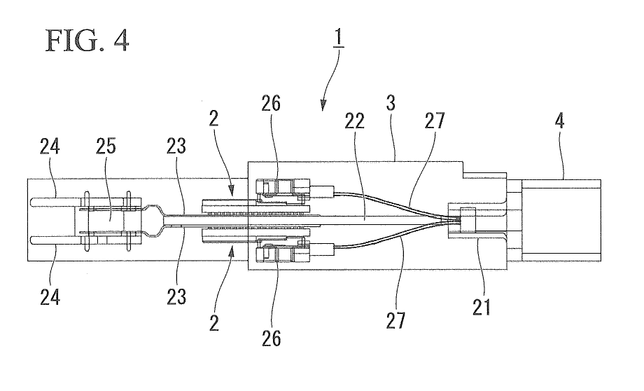

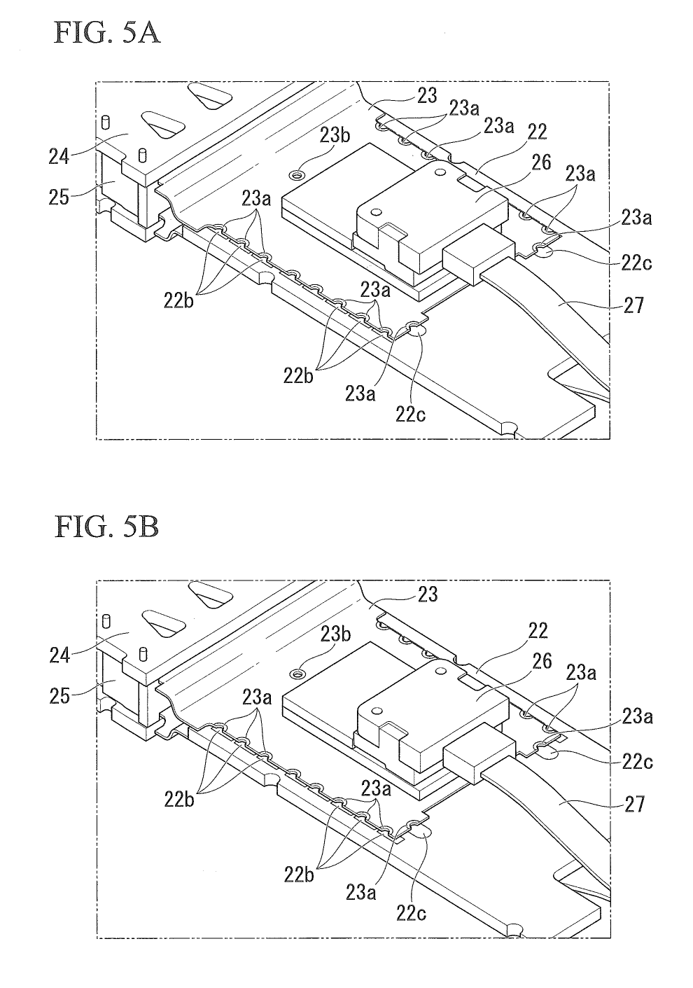

FIG. 3 is a perspective view showing an overview of the optical transceiver body 2. FIG. 4 is an internal structure diagram seen from the side of the base 3 for a state in which the optical transceiver body 2 is housed in the base 3. In FIG. 4, the inner cover 5 and the outer cover 6 are not attached to the base 3. FIG. 5A and FIG. 5B are partially enlarged views of the optical transceiver body 2. The optical transceiver body 2 in FIG. 5A and the optical transceiver body 2 in FIG. 5B are exactly the same, except that the position of a flexible board 23 with respect to a main board 22 described later is different.

In FIG. 3, in addition to the optical connector 21, the main board 22, and the flexible board 23 described above, the optical transceiver body 2 includes a card edge board 24, a spacer 25, an optical module 26, and a multicore optical fiber 27. As shown in the internal structure in FIG. 4, in the optical transceiver 1 according to the present exemplary embodiment, two flexible boards 23, two card edge boards 24, two optical modules 26, and two optical fibers 27 are provided in the optical transceiver body 2. That is to say, two sets of component groups including the flexible board 23, the card edge board 24, the optical module 26, and the optical fiber 27 are provided in the optical transceiver body 2. In this case, one of the component groups is provided on the front surface side of the main board 22, and the other component group is provided on the rear surface side of the main board 22. Because respective groups have the same configuration, the group provided on the front surface side of the main board 22 will be described below.

In FIG. 3, the main board 22 is formed in a rectangular shape. A notch 22a is formed in a central part of a tip section of the main board 22 (the left side on the sheet in FIG. 3 is designated as the tip section). The notch 22a is substantially a U shape, and is used to allow passage of the optical fiber 27 therethrough. As shown in partially enlarged views in FIGS. 5A and 5B, a plurality of solder pads 22b is provided at the respective side edges of the main board 22 in the longitudinal direction. The number of solder pads 22b is the same as that of a plurality of solder pads 23a (details of the shape and the like will be described later) provided at the respective side edges of the flexible board 23 in the longitudinal direction. The solder pads 22b have a rectangular shape. The size of the solder pads 22b is larger than the solder pads 23a of the flexible board 23. The solder pads 22b are provided along the longitudinal direction of the main board 22 with a certain gap therebetween.

An elliptical solder pad (not shown) having a larger size than the solder pad 23a of the flexible board 23, is provided on the main board 22. The elliptical solder pad is provided corresponding to a solder pad 23b (details of the shape and the like will be described later) provided at a central part adjacent to the card edge board 24.

Elliptical solder pads 22c are provided on the main board 22. The solder pads 22c have roughly the same size as that of the aforementioned elliptical solder pad (not shown) and have the same shape. The solder pads 22c are provided corresponding to respective two solder pads 23a provided at the side edges on the tip side of the flexible board 23 (the right side on the sheet in FIG. 5A and FIG. 5B is designated as the tip side).

The length of the flexible board 23 is shorter than the main board 22. The flexible board 23 is formed in a rectangular shape, and is arranged on the surface of the main board 22. The optical module 26 is mounted on the flexible board 23. Respective wiring (not shown) provided on the flexible board 23 are connected to respective terminals of the optical module 26, and are also connected to a card edge terminal (not shown) of the card edge board 24. As shown in the enlarged views in FIGS. 5A and 5B, a plurality of solder pads 23a is provided at the respective side edges of the flexible board 23 in the longitudinal direction. The solder pads 23a have a half-ring shape. The solder pads 23a are provided along the longitudinal direction of the flexible board 23 with a certain gap therebetween. One solder pad 23b is provided in a central part of the flexible board 23 adjacent to the card edge board 24. The solder pad 23b has a ring shape. Two solder pads 23a are provided at the side edges on the tip side of the flexible board 23. The solder pads 23a have a half-ring shape.

For example, copper foil may be used for the solder pads 22b, 22c, 23a, and 23b described above. When the solder pads 22b, 22c, 23a, and 23b are manufactured from copper foil, it is desired to deposit solder on the surface of the solder pad to prevent rust.

By soldering together the pads 23a and 23b on the flexible board 23 and the pads 22b and 22c (including solder pads (not shown)) on the main board 22, the flexible board 23 can be fitted to the main board 22. At the time of fitting the flexible board 23 to the main board 22, a radius of curvature of the optical fiber 27 that connects the optical module 26 and the optical adaptor 4 is maintained constant. In this state, the position of the flexible board 23 is adjusted with respect to a line length direction of the optical fiber 27, depending on a variation in the length of the optical fiber 27 and a deviation amount of a mounting position of the optical module 26 on the flexible board 23. At this time, the solder pads 22b and 22c (including solder pads (not shown)) on the main board 22 side are formed large, taking into consideration the variation in the length of the optical fiber 27 and mounting variability of the optical module 26 on the flexible board 23. Consequently, even if the position of the flexible board 23 with respect to the main board 22 is changed, soldering can be performed.

The card edge board 24 needs to be incorporated in the base 3 in a state with the position of the card edge board 24 with respect to the base 3 being constant. One end portion of the flexible board 23 is connected to the wiring of the card edge board 24 so as to protrude from the rear end of the main board 22. Consequently, a deviation due to a change of the position of the flexible board 23 can be absorbed by the curvature of the flexible board 23. As a result, the card edge board 24 can be incorporated in the base 3 in a state with the position of the card edge board 24 with respect to the base 3 being constant.

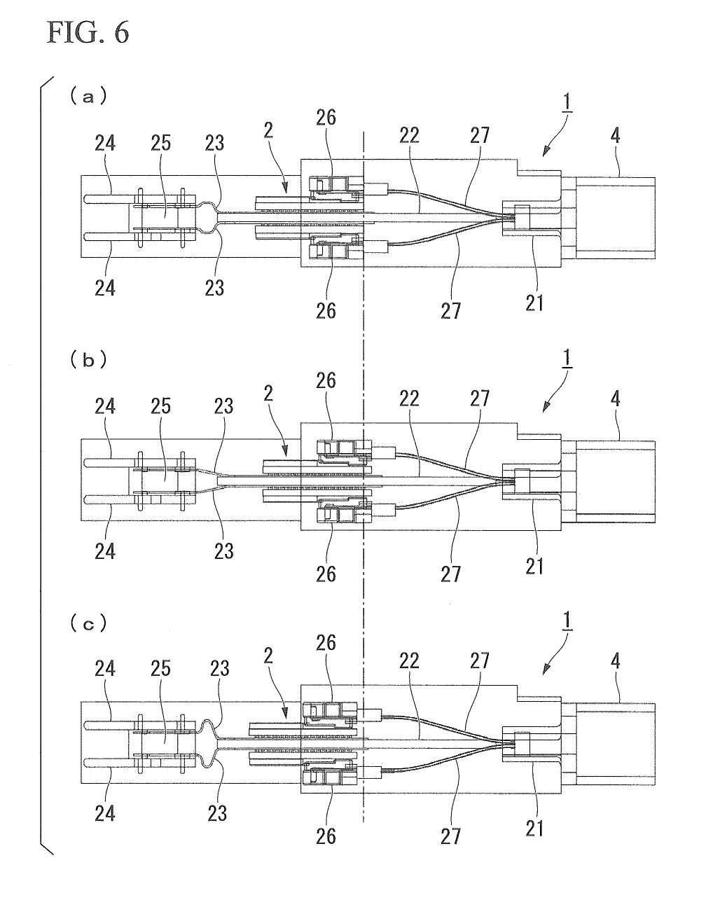

FIG. 6 shows examples in which position adjustment of the flexible board 23 is performed with respect to the line length direction of the optical fiber 27, thereby absorbing the variation in the length of the optical fiber 27 and the mounting variability of the optical module 26 on the flexible board 23. Portion (a) of FIG. 6 shows position adjustment when the optical fiber 27 is slightly longer than normal or the optical module 26 is mounted on the flexible board 23 close to the card edge board 24. In this case, the flexible board 23 is displaced toward the card edge board 24 side in the line length direction of the optical fiber 27. By such an adjustment, the variation in the length of the optical fiber 27 and the deviation amount of the mounting position of the optical module 26 on the flexible board 23 can be absorbed, while maintaining the constant radius of curvature of the optical fiber 27.

Portion (b) of FIG. 6 shows position adjustment when the optical fiber 27 is shorter than normal or the optical module 26 is mounted on the flexible board 23 close to the optical adaptor 4. In this case, the flexible board 23 is displaced toward the optical adaptor 4 side in the line length direction of the optical fiber 27. By such an adjustment, the variation in the length of the optical fiber 27 and the deviation amount of the mounting position of the optical module 26 on the flexible board 23 can be absorbed, while maintaining the constant radius of curvature of the optical fiber 27.

Portion (c) of FIG. 6 shows position adjustment when the optical fiber 27 is longer than the case of Portion (a) of FIG. 6 or the optical module 26 is mounted on the flexible board 23 closer to the optical adaptor 4 than the case of Portion (a) of FIG. 6. In this case, the flexible board 23 is displaced toward the card edge board 24 side in the line length direction of the optical fiber 27. By such an adjustment, the variation in the length of the optical fiber 27 and the deviation amount of the mounting position of the optical module 26 on the flexible board 23 can be absorbed, while maintaining the constant radius of curvature of the optical fiber 27.

In FIG. 3, the card edge board 24 includes a plurality of terminals (not shown) at an edge of the side opposite to the side connected to the flexible board 23. The card edge board 24 can be connected to external wiring by these terminals The two card edge boards 24 provided on both the front surface side and the rear surface side of the main board 22 are positioned and fixed by the spacer 25.

In this way, according the optical transceiver 1 of the present exemplary embodiment, the flexible board 23 can be fixed to the main board 22 at an arbitrary position within a predetermined range (a range according to the size of the solder pads 22c and 22c (including solder pads (not shown) on the main board 22) in the a length direction of the optical fiber 27. Moreover, the two card edge boards 24 provided on both the front surface side and the rear surface side of the main board 22 are positioned and fixed by the spacer 25. According to such a configuration, the variation in the length of the optical fiber 27 and the deviation amount of the mounting position of the optical module 26 on the flexible board 23 can be absorbed, while maintaining the constant radius of curvature of the optical fiber 27. As a result, the optical transceiver body 2 can be housed efficiently in the base 3, and the optical transceiver 1 can be downsized.

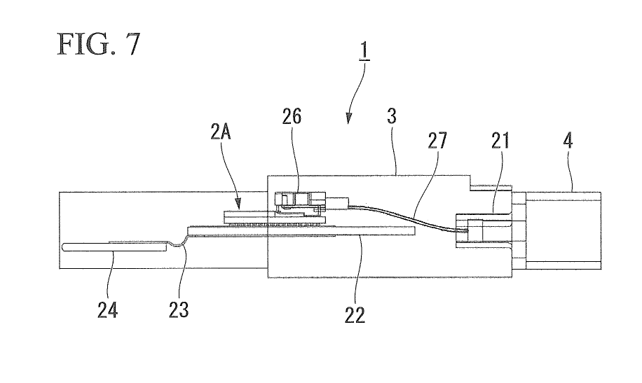

In the optical transceiver 1 according to the present exemplary embodiment, two sets of component groups including the flexible board 23, the card edge board 24, the optical module 26, and the optical fiber 27, are provided in the optical transceiver body 2. However, only one set of component group may be provided in the optical transceiver body 2. FIG. 7 is an internal structure diagram seen from the side of the base 3 for a state in which an optical transceiver body 2A provided with a component group of one set including the flexible board 23, the card edge board 24, the optical module 26, and the optical fiber 27, is housed in the base 3.

A part or the whole of the exemplary embodiment described above may be described as in the following supplementary notes, but is not limited to this.

(Supplementary Note 1) An optical transceiver including:

a main board;

a flexible board provided on a surface of the main board;

an optical module mounted on the flexible board; and

an optical fiber connected to the optical module,

wherein a position of the flexible board with respect to the main board is freely adjusted in a length direction of the optical fiber.

(Supplementary Note 2) The optical transceiver according to supplementary note 1, further including:

a card edge board provided on a same surface side as the flexible board with respect to the main board, the card edge board connected to wiring of the flexible board at one end portion of the flexible board.

(Supplementary Note 3) The optical transceiver according to supplementary note 2, wherein

the flexible board includes: a first flexible board provided on a first surface of the main board; and a second flexible board provided on a second surface of the main board which is a rear surface of the first surface,

the card edge board includes: a first card edge board connected to wiring of the first flexible board; and a second card edge board connected to wiring of the second flexible board, and

the transceiver further includes: a spacer which positions and fixes the first card edge board and the second card edge board.

(Supplementary Note 4) The optical transceiver according to any one of supplementary notes 1 to 3, further including:

an optical connector connected to an open end side of the optical fiber.

(Supplementary Note 5) The optical transceiver according to any one of supplementary notes 1 to 4, wherein

the flexible board includes at least a plurality of solder pads at a side edge in a same direction as a line length direction of the optical fiber, the plurality of solder pads arranged along the line length direction of the optical fiber, and

the main board includes at least a plurality of solder pads arranged at positions facing the respective plurality of solder pads of the flexible board.

(Supplementary Note 6) The optical transceiver according to any one of supplementary notes 1 to 5, wherein a solder pad of the main board is larger than a solder pad of the flexible board.

(Supplementary Note 7) The optical transceiver according to supplementary note 6, wherein the solder pad on the main board has a size capable of absorbing a variation in a length of the optical fiber and mounting variability of the optical module on the flexible board.

(Supplementary Note 8) The optical transceiver according to any one of supplementary notes 5 to 7, wherein the solder pad of the flexible board has a half ring shape, and

the solder pad on the main board has a rectangular shape extending in the line length direction of the optical fiber.

(Supplementary Note 9) The optical transceiver according to any one of supplementary notes 1 to 8, wherein one end portion of the flexible board is connected to wiring of the card edge board so as to protrude from an end of the main board.

The invention of the present application has been described above with reference to the exemplary embodiment. However, the invention of the present application is not limited to the exemplary embodiment. Various changes that can be understood by a person skilled in the art can be made to the configuration and details of the invention of the present application, within the scope of the invention of the present application.

This application is based upon and claims the benefit of priority from Japanese patent application No. 2012-004895, filed Jan. 13, 2012, the disclosure of which is incorporated herein in its entirety by reference.

### INDUSTRIAL APPLICABILITY

The present invention is applicable to an optical communication device.

### Reference Symbols

1 Optical transceiver
2 Optical transceiver body
3 Base
4 Optical adaptor
5 Inner cover
6 Outer cover
21 Optical connector
22 Main board
22b, 22c Solder pad
23 Flexible board
23a, 23b Solder pad
24 Card edge board
25 Spacer
26 Optical module
27 Optical fiber

1. An optical transceiver comprising:
a main board;
a flexible board provided on a surface of the main board;
an optical module mounted on the flexible board; and
an optical fiber connected to the optical module,
wherein a position of the flexible board with respect to the main board is freely adjusted in a length direction of the optical fiber.

2. The optical transceiver according to claim 1, further comprising:
a card edge board provided on a same surface side as the flexible board with respect to the main board, the card edge board connected to wiring of the flexible board at one end portion of the flexible board.

3. The optical transceiver according to claim 2, wherein
the flexible board includes: a first flexible board provided on a first surface of the main board; and a second flexible board provided on a second surface of the main board which is a rear surface of the first surface,
the card edge board includes: a first card edge board connected to wiring of the first flexible board; and a second card edge board connected to wiring of the second flexible board, and
the transceiver further comprises: a spacer which positions and fixes the first card edge board and the second card edge board.

4. The optical transceiver according to claim 1, further comprising:
an optical connector connected to an open end side of the optical fiber.

5. The optical transceiver according to claim 1, wherein
the flexible board includes at least a plurality of solder pads at a side edge in a same direction as a line length direction of the optical fiber, the plurality of solder pads arranged along the line length direction of the optical fiber, and
the main board includes at least a plurality of solder pads arranged at positions facing the respective plurality of solder pads of the flexible board.

6. The optical transceiver according to claim 1, wherein a solder pad of the main board is larger than a solder pad of the flexible board.

7. The optical transceiver according to claim 6, wherein the solder pad on the main board has a size capable of absorbing a variation in a length of the optical fiber and mounting variability of the optical module on the flexible board.

8. The optical transceiver according to claim 5, wherein the solder pad of the flexible board has a half ring shape, and
the solder pad on the main board has a rectangular shape extending in the line length direction of the optical fiber.

9. The optical transceiver according to claim 1, wherein one end portion of the flexible board is connected to wiring of the card edge board so as to protrude from an end of the main board.
